(19) United States
(12) Patent Application Publication
(10) Pub. No.: US 2007/0285699 A1
(43) Pub. Date: Dec. 13, 2007

(54) IMAGE FORMING SYSTEM, IMAGE FORMING APPARATUS, METHOD FOR CONTROLLING IMAGE FORMING APPARATUS, PROGRAM FOR CONTROLLING IMAGE FORMING APPARATUS, INFORMATION MANAGING APPARATUS, INFORMATION MANAGING METHOD, AND INFORMATION MANAGING PROGRAM

(75) Inventor: Akira Kamimura, Ota-ku (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/758,109

(22) Filed: Jun. 5, 2007

(30) Foreign Application Priority Data
Jun. 7, 2006 (JP) 2006-158336

(51) Int. Cl. G06F 3/12

(52) U.S. Cl. 358/1.13

(57) ABSTRACT

In an image forming system of the present invention, each of the information processing apparatuses receives an input whether print of the image forming job is to be held or executed, sets whether print of the image forming job is to be held or executed, generates a user packet, and transmits the generated user packet to the image forming apparatus, and the image forming apparatus receives the image forming job, identifies the information processing apparatus based on identification data, updates a queue management table, determines whether or not print of the image forming job received is instructed referring to the updated queue management table, and holds print of the image forming job and sequentially prints the image forming job. According to the image forming system of the present invention, a user can continuously execute a plurality of jobs at a desired timing.

### BACKGROUND OF THE INVENTION

1. Field of the Invention

The present invention relates to an image forming system, an image forming apparatus, a method of controlling the image forming apparatus, and a program for controlling the image forming apparatus as well as to an information managing apparatus, an information managing method, and an information managing program, and more particularly, to an image forming system, an image forming apparatus, a method of controlling the image forming apparatus, and a program for controlling the image forming apparatus which can execute print according to a job instructed from a user as well as to an information managing apparatus, an information managing method, and an information managing program.

2. Description of the Related Art

In general, an image forming apparatus such as a copy machine, a printer, and the like is connected to a network. The image forming apparatus sequentially receives print instructions from a plurality of users through the personal computers of them connected to the network and carries out print according to the print instructions.

Thus, when a user intends to cause the image forming apparatus to sequentially execute a plurality of jobs, the plurality of jobs may be interrupted by jobs from other users. In this case, a disadvantage arises in that printed matters printed corresponding to the jobs from the other users are mixed in addition to the printed matters printed corresponding to the jobs from the above user.

According to a technology proposed by Japanese Unexamined Patent Application Publication No. 7-334329, to prevent the above circumstances, the jobs to be processed by an image forming apparatus are managed for each of users using a queue management table, and print is controlled such that when print jobs of a user start once, only the jobs of the user are executed as long as they exist in the queue management table, and jobs of other user are not executed.

In the technology proposed by Japanese Unexamined Patent Application Publication No. 7-334329, it is possible for the image forming apparatus to automatically recognize a user (or a personal computer and the like) and to execute the jobs of the user in a lot. However, the technology is disadvantage in that not only the image forming apparatus is occupied by only one user during a predetermined period of time in which the jobs of the user are being executed in a lot as well as the user cannot intentionally cause the image forming apparatus to flexibly execute print up to a certain range of jobs and thus the user cannot obtain a result of print operation he or she desires.

Accordingly, an object of the present invention, which was made in view of the above circumstances, is to provide an image forming system, an image forming apparatus, a method of controlling the image forming apparatus, and a program for controlling the image forming apparatus which can continuously carry out a plurality of job at a timing preferable to a user as well as to an information managing apparatus, an information managing method, and an information managing program.

### SUMMARY OF THE INVENTION

To solve the above problem, in an image forming system according to an aspect of the present invention composed of a plurality of information processing apparatuses each transmitting an image forming job and an image forming apparatus connected to the information processing apparatuses via a network for executing the image forming job transmitted from each of the information processing apparatuses, each of the information processing apparatuses is composed of an input receiving unit configured to receive an input whether print of the image forming job is to be held or executed, a setting unit configured to set whether print of the image forming job is to be held or executed based on the input, which is received by the input receiving unit, whether print of the image forming job is to be held or executed, a generation unit configured to generate a user packet by using the set data, which is set by the setting unit, whether print of the image forming job is to be held or executed and by using the image forming data included in an obtained print request, and a transmission unit configured to transmit the user packet generated by the generation unit to the image forming apparatus as the image forming job, and the image forming apparatus is composed of a receiving unit configured to receive the image forming job transmitted by the transmission unit from each of the information processing apparatuses, an identification unit configured to identify the information processing apparatus from which the image forming job is transmitted from the plurality of the image processing apparatuses connected to the network based on identification data for identifying the information processing apparatus included in the image forming job received by the receiving unit, an update unit configured to update a queue management table for managing the image forming job in accordance with a result of identification identified by the identification unit based on the image forming job received by the receiving unit, a determination unit configured to determine whether or not print of the image forming job received by the receiving unit is instructed referring to the queue management table updated by the update unit, and a print/hold execution unit configured to hold print of the image forming job when it is determined by the determination unit that hold of print of the image forming job is instructed and continuously and sequentially print the image forming jobs whose print is held up to that time when it is determined by the determination unit that print of the image forming job is instructed.

To solve the above problem, in an image forming system according to an aspect of the present invention composed of a plurality of information processing apparatuses each transmitting an image forming job, an information managing apparatus connected to the information processing apparatuses via a network for managing the image forming job transmitted from each of the information processing apparatuses, and an image forming apparatus connected to the information processing apparatuses and the information managing apparatus via the network for executing the image forming job transmitted from the information managing apparatus, each of the information processing apparatuses is composed of an input receiving unit configured to receive an input whether print of the image forming job is to be held or executed, a setting unit configured to set whether print of the image forming job is to be held or executed based on the input, which is received by the input receiving unit, whether print of the image forming job is to be held or executed, a generation unit configured to generate a user packet by using the set data, which is set by the setting unit, whether print of the image forming job is to be held or executed and by using the image forming data included in an obtained print request, and a transmission unit for transmitting the user packet generated by the generation unit to the image forming apparatus as the image forming job, and the information managing apparatus is composed of a receiving unit configured to receive the image forming job transmitted by the transmission unit from each of the information processing apparatuses, an identification unit configured to identify the information processing apparatus from which the image forming job is transmitted from the plurality of the image processing apparatuses connected to the network based on identification data for identifying the information processing apparatus included in the image forming job received by the receiving unit, an update unit configured to update a queue management table for managing the image forming job in accordance with a result of identification identified by the identification unit based on the image forming job received by the receiving unit, a determination unit configured to determine whether or not print of the image forming job received by the receiving unit is instructed referring to the queue management table updated by the update unit, and a print/hold execution unit configured to cause the image forming apparatus to hold print of the image forming job when it is determined by the determination unit that hold of print of the image forming job is instructed and to cause the image forming apparatus to continuously and sequentially print the image forming jobs whose print is held up to that time when it is determined by the determination unit that print of the image forming jobs is instructed.

To solve the above problem, an image forming apparatus of an aspect of the present invention is composed of a receiving unit configured to receive an image forming job transmitted from each of a plurality of information processing apparatuses connected to an image forming apparatus via a network, an identification unit configured to identify the information processing apparatus from which the image forming job is transmitted from the plurality of image processing apparatuses connected to the network based on identification data for identifying the information processing apparatus included in the image forming job received by the receiving unit, an update unit configured to update a queue management table for managing the image forming job in accordance with a result of identification identified by the identification unit based on the image forming job received by the receiving unit, a first determination unit configured to determine whether or not print of the image forming job received by the receiving unit is instructed referring to the queue management table updated by the update unit, and a print/hold execution unit configured to hold print of the image forming job when it is determined by the first determination unit that hold of print of the image forming job is instructed and continuously and sequentially print the image forming job whose print is held up to that time when it is determined by the first determination unit that print of the image forming job is instructed.

To solve the above problem, a method of controlling an image forming apparatus of an aspect of the present invention is composed of receiving an image forming job transmitted from each of information processing apparatuses connected to an image forming apparatus via a network, identifying the information processing apparatus from which the image forming job is transmitted from the plurality of information processing apparatuses connected to the network based on identification data for identifying the information processing apparatus included in the image forming job processing apparatus received, updating a queue management table for managing the image forming job in accordance with a result of identification executed based on the image forming job received, determining whether or not print of the image forming job received is instructed referring to the queue management table updated, and holding print of the image forming job when it is determined that hold of print of the image forming job is instructed and for continuously and sequentially printing the image forming job whose print is held up to that time when it is determined that print of the image forming job is instructed.

To solve the above problem, in a control program of an image forming apparatus of an aspect of the present invention, the control program causes a computer to execute receiving an image forming job transmitted from each of information processing apparatuses connected to an image forming apparatus via a network, identifying the information processing apparatus from which the image forming job is transmitted from the plurality of information processing apparatuses connected to the network based on identification data for identifying the information processing apparatus included in the image forming job processing apparatus received, updating a queue management table for managing the image forming job in accordance with a result of identification executed based on the image forming job received, determining whether or not print of the image forming job received is instructed referring to the queue management table updated, and holding print of the image forming job when it is determined that hold of print of the image forming job is instructed and for continuously and sequentially printing the image forming job whose print is held up to that time when it is determined that print of the image forming job is instructed.

To solve the above problem, an information managing apparatus of an aspect of the present invention is composed of a receiving unit configured to receive an image forming job transmitted from each of a plurality of information processing apparatuses connected to an information managing apparatus via a network, an identification unit configured to identify the information processing apparatus from which the image forming job is transmitted from the plurality of image processing apparatuses connected to the network based on identification data for identifying the information processing apparatus included in the image forming job received by the receiving unit, an update unit configured to update a queue management table for managing the image forming job in accordance with a result of identification identified by the identification unit based on the image forming job received by the receiving unit, a determination unit configured to determine whether or not print of the image forming job received by the receiving unit is instructed referring to the queue management table updated by the update unit, and a print/hold execution unit configured to cause the image forming apparatus connected via the network to hold print of the image forming job when it is determined by the determination unit that hold of print of the image forming job is instructed and to cause the image forming apparatus to continuously and sequentially printing the image forming job whose print is held up to that time when it is determined by the determination unit that print of the image forming job is instructed.

To solve the above problem, an information managing method of an aspect of the present invention is composed of receiving an image forming job transmitted from each of information processing apparatuses connected to an information managing apparatus via a network, identifying the information processing apparatus from which the image forming job is transmitted from the plurality of information processing apparatuses connected to the network based on identification data for identifying the information processing apparatus included in the image forming job processing apparatus, updating a queue management table for managing the image forming job in accordance with a result of identification executed based on the image forming job received, determining whether or not print of the image forming job received is instructed referring to the queue management table updated, and causing an image forming apparatus connected via the network to hold print of the image forming job when it is determined that hold of print of the image forming job is instructed and for causing the image forming apparatus to continuously and sequentially print the image forming job whose print is held up to that time when it is determined that print of the image forming job is instructed.

To solve the above problem, in an information managing program of an aspect of the present invention, the information managing program causes a computer to execute receiving an image forming job transmitted from each of a plurality of information processing apparatuses connected to an information managing apparatus via a network, identifying the information processing apparatus from which the image forming job is transmitted from the plurality of information processing apparatuses connected to the network based on identification data for identifying the information processing apparatus included in the image forming job processing apparatus received, updating a queue management table for managing the image forming job in accordance with a result of identification executed based on the image forming job received, determining whether or not print of the image forming job received is instructed referring to the queue management table updated, and causing an image forming apparatus connected via the network to hold print of the image forming job when it is determined that hold of print of the image forming job is instructed and for causing the image forming apparatus to continuously and sequentially print the image forming job whose print is held up to that time when it is determined that print of the image forming job is instructed.

### BRIEF DESCRIPTION OF THE DRAWINGS

In the accompanying drawings:

FIG. 1 is a view showing a schematic construction of an image forming system of a first embodiment of the present invention;

FIG. 2 is a block diagram showing an internal construction of a personal computer of FIG. 1;

FIG. 3 is a block diagram showing an internal construction of the image forming apparatus of FIG. 1;

FIG. 4 is a view showing a functional construction which can be executed by the personal computer of FIG. 2.

FIG. 5 is a view showing a functional construction which can be carried out by the image forming apparatus of FIG. 3;

FIG. 6 is a flowchart explaining an image forming job transmission processing in the personal computer of FIG. 4;

Parts (A) and (B) of FIG. 7 are views showing an construction example of user packets generated by a user packet generation processing in Step S4 of FIG. 6;

FIG. 8 is a flowchart explaining a print execution processing in the image forming apparatus of FIG. 5;

FIG. 9 is a view showing a construction example of a queue management table;

FIG. 10 is a flowchart explaining other print execution processing in the image forming apparatus of FIG. 5;

FIG. 11 is a view showing a functional construction which can be carried out by an image forming apparatus of a second embodiment of the present invention;

FIG. 12 is a flowchart explaining a print execution processing in the image forming apparatus of FIG. 11;

FIG. 13 is a view showing a schematic construction of another image forming system of the present invention; and

FIG. 14 is a block diagram showing an internal construction of a host server of FIG. 13; and

FIG. 15 is a view showing a functional construction which can be carried out by the host server of FIG. 14.

### DESCRIPTION OF THE PREFERRED EMBODIMENTS

Embodiments of the present invention will be explained below with reference to the drawings.

### First Embodiment

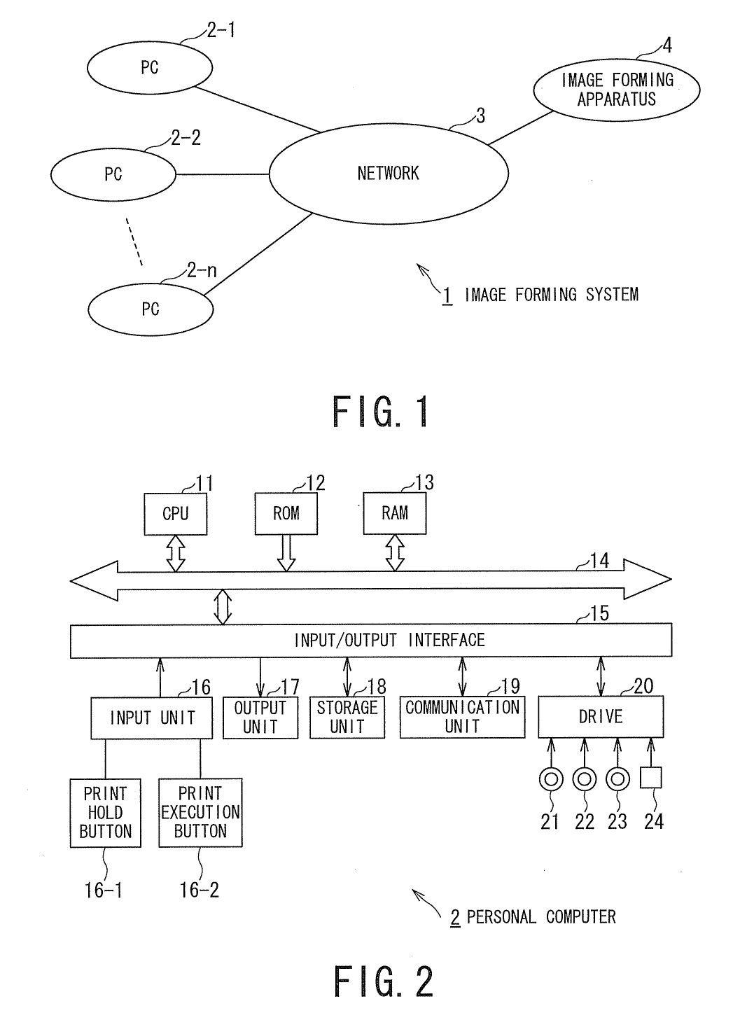

FIG. 1 shows a schematic construction of an image forming system 1 of a first embodiment of the present invention. As shown in FIG. 1, in the image forming system 1, a plurality of personal computers 2-1 to 2-n (information processing apparatuses according to the present invention) allocated to respective users are connected to a network 3 (including, for example, The Internet, LAN, WAN, and other various types of networks). Further, in the image forming system 1, an image forming apparatus 4 is connected to the network 3.

Note that, hereinafter, when it is not necessary to individually discriminate the personal computers 2-1 to 2-n, they are generically called personal computers 2.

FIG. 2 shows an internal construction of each of the personal computers 2 of FIG. 1.

As shown in FIG. 2, a CPU 11 executes various types of processing according to a program stored to a ROM 12 or a program loaded from a storage unit 18 to a RAM 13.

The RAM 13 further appropriately stores data and the like which are necessary for the CPU 11 to carry out the various types of the processing.

The CPU 11, the ROM 12, and the RAM 13 are connected to each other via a bus 14. An input/output interface 15 is also connected to the bus 14.

Connected to the input/output interface 15 are an input unit 16 composed of a keyboard, a mouse, a print hold button 16-1, a print execution button 16-2, and the like, a display composed of a CRT, an LCD, and the like; an output unit 17 composed of a speaker, and the like, a storage unit 18 composed of a hard disk and the like, and a communication unit 19 composed of a modem, a terminal adapter, a network interface (any of them is not shown), and the like.

Note that a user can instruct to hold print of an image forming job by operating the print hold button 16-1 of the input unit 16. In contrast, the user can instruct to execute print of the image forming job by operating the print execution button 16-2 of the input unit 16.

The communication unit 19 carries out a communication processing via the network 3.

The input/output interface 15 has a drive 20 connected thereto when necessary as well as has a magnetic disk 21 (including a floppy disk), an optical disk 22 (including a CD-ROM and a DVD), an optical magnetic disk 23 (including an MD), a semiconductor memory 24, and the like appropriately mounted thereon, and computer programs read therefrom are installed to the storage unit 18 when necessary.

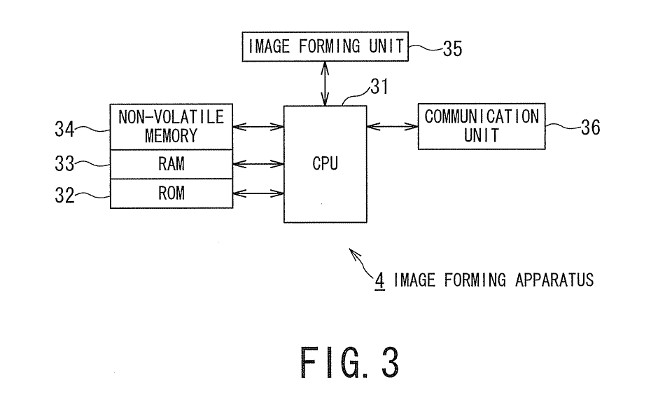

FIG. 3 shows a schematic interior construction of the image forming apparatus 4 of FIG. 1.

As shown in FIG. 3, connected to a CPU 31 acting as a main controller are a ROM 32 to which a predetermined operation rule and initial data are stored, a RAM 33 for temporarily storing input control data, a result of arithmetic operation processing executed by the CPU 31, and the like, an NVM 34 for holding data stored up to that time by being backed up by a battery even if power to the image forming apparatus 4 is disconnected, an image forming unit 35 for forming an image according to a job by subjecting image data to a predetermined image processing, a communication unit 36 for carrying out a communication processing via the network 3, and the like.

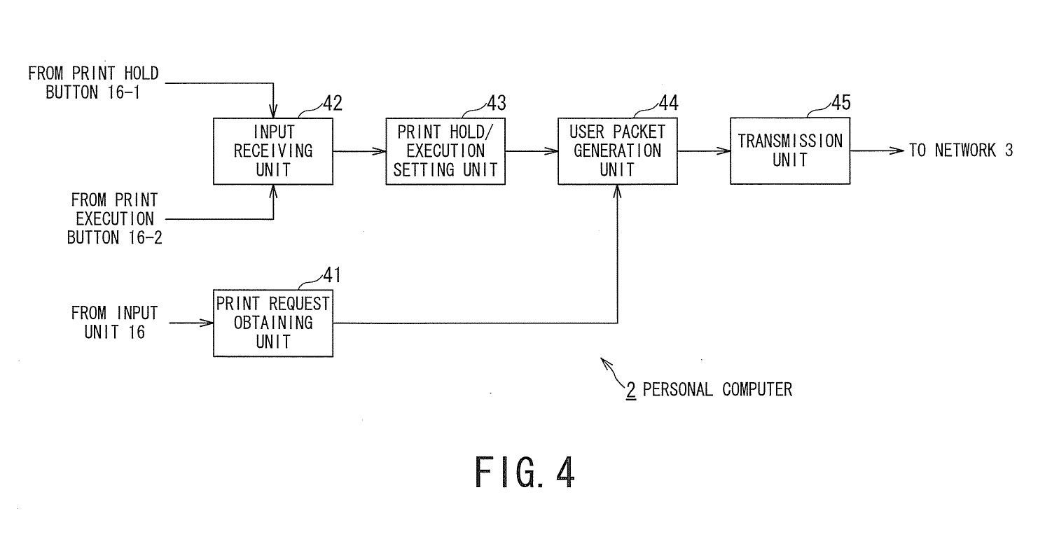

FIG. 4 shows a functional construction which can be executed by the personal computers 2 of FIG. 2.

When the input unit 16 is operated by the user, a print request obtaining unit 41 obtains a print request for requesting print of predetermined image forming data PD and supplies the obtained print request to a user packet generating unit 44.

When the user operates the print hold button 16-1 or the print execution button 16-2 of the input unit 16, an input receiving unit 42 receives an input whether print of an image forming job is to be held or executed and supplies an input whether or not print of the received image forming job is to be held or executed to a print hold/execution setting unit 43.

The print hold/execution setting unit 43 obtains the input whether print of the image forming job supplied from the input receiving unit 42 is to be held or executed and sets whether print of the image forming job is to be held or executed based on the input whether print of the obtained image forming job is to be held or executed. The print hold/execution setting unit 43 supplies the set data whether print of the set image forming job is to be held or executed to the user packet generating unit 44.

The user packet generating unit 44 obtains the print request supplied from the print request obtaining unit 41 as well as obtains the set data, which is supplied from the print hold/execution setting unit 43, as to whether print of the image forming job is to be held or executed, generates a user packet based on the obtained print request and on the obtained set data whether print of the image forming job is to be held or executed, and supplies the generated user packet to a transmission unit 45.

The user packet is added with a packet to which identification data (for example, an IP address a MAC address, and the like) is stored to identify the personal computers 2. It is needless to say that identification data other than the above identification data may be added.

The transmission unit 45 obtains the user packet supplied from the user packet generating unit 44 and transmits the obtained user packet to the image forming apparatus 4 via the network 3 as the image forming job.

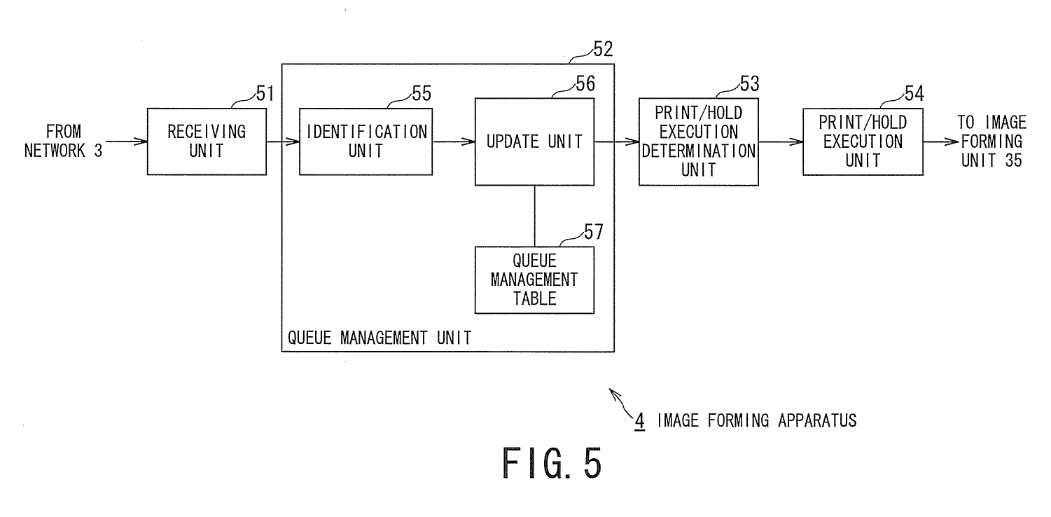

FIG. 5 shows a functional construction which can be executed by the image forming apparatus 4 of FIG. 3.

A receiving unit 51 appropriately receives the image forming jobs supplied from the personal computers 2 (personal computers 2-1 to 2-n), respectively via the network 3 and supplies the received image forming jobs to a queue management unit 52.

The queue management unit 52 is composed of an identification unit 55, an update unit 56 for appropriately updating a queue management table 57, and the like. The identification unit 55 obtains the image forming jobs supplied from the receiving unit 51 and identifies the personal computers from which the image forming jobs are supplied based on the identification data (identification data for identifying the respective personal computers 2) included in the user packets of the obtained image forming jobs. In other words, the identification unit 55 identifies the users who operate the personal computers from which the image forming jobs are supplied.

The update unit 56 appropriately updates the queue management table 57 for managing the respective image forming jobs according to a result of identification supplied from the identification unit 55 based on the image forming jobs transmitted via the network 3.

A print/hold execution determination unit 53 reads a latest queue management table 57 managed by the queue management unit 52, determines whether print of the image forming jobs received via the network 3 is to be held or to be executed based on the read queue management table 57 and supplies a result of determination to a print/hold execution unit 54.

The print/hold execution unit 54 obtains the result of determination supplied from the print/hold execution determination unit 53 and controls the image forming unit 35 based on the obtained result of determination to thereby hold or execute print of the image forming jobs received via the network 3.

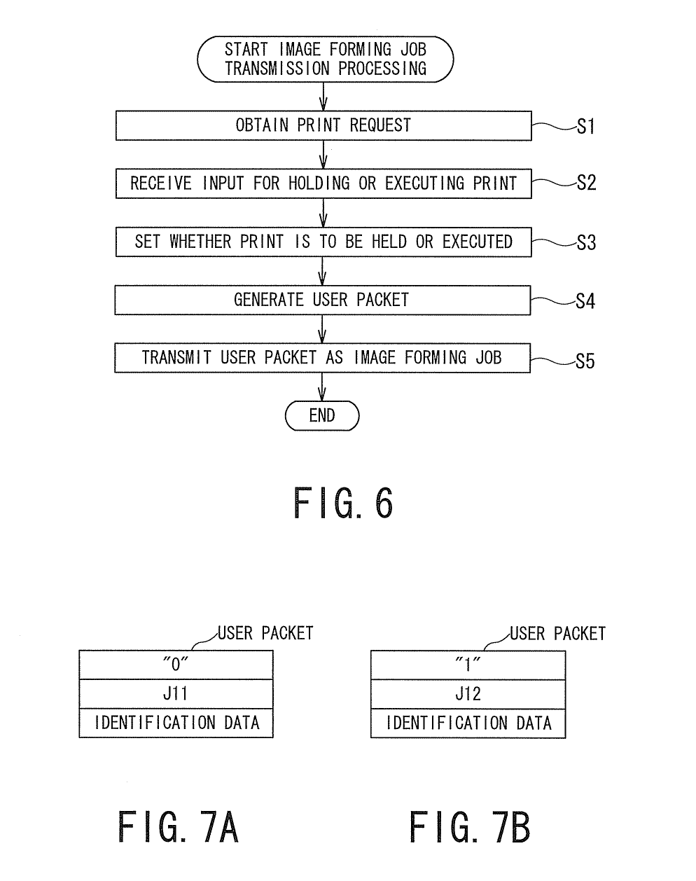

Next, an image forming job transmission processing in the personal computer 2 of FIG. 4 will be explained referring to a flowchart of FIG. 6. The image forming job transmission processing is started by a user who instructs a new print request by operating the personal computer 2.

In Step S1, when the user operates the input unit 16, the print request obtaining unit 41 obtains a print request for requesting to print the predetermined image forming data PD and supplies the obtained print request to the user packet generating unit 44. In Step S2, when the user operates the print hold button 16-1 or the print execution button 16-2 of the input unit 16, the input receiving unit 42 receives an input whether print of an image forming job is to be held or executed and supplies an input whether print of the received image forming job is to be held or executed to the print hold/execution setting unit 43.

In Step S3, the print hold/execution setting unit 43 obtains an input whether print of the image forming job supplied from the input receiving unit 42 is to be held or executed and sets whether print of the image forming job is to be held or executed based on the obtained input whether print of the image forming job is to be held or executed. The print hold/execution setting unit 43 supplies the set data whether print of the image forming job is to be held or executed to the user packet generating unit 44.

With these operations, when print of the predetermined image forming data PD is requested, it can be set whether the image forming apparatus 4 temporarily holds or instantly carries out print of the image forming data PD.

Note that in the embodiment of the present invention, although whether print of an image forming job is to be held or executed is set in such a manner that a user operates the print hold button 16-1 or the print execution button 16-2 of the input unit 16, the present invention is not limited thereto, and whether it is to be held or executed may be set by, for example, operating a message dialogue, an icon, and the like displayed on the output unit 17 using the input unit 16.

In Step S4, the user packet generating unit 44 obtains the print request supplied from the print request obtaining unit 41 as well as obtains the set data, which is supplied from the print hold/execution setting unit 43, as to whether print of the image forming job is to be held or executed, and generates a user packet based on the obtained print request and on the obtained set data whether print of the image forming job is to be held or executed.

As shown in, for example, a part (A) of FIG. 7, when an input for holding print of the image forming job is received by that the user operates the print hold button 16-1, “0”, which is data indicating to hold print of the image forming job is generated based on the set data for holding print of the image forming job, and a user packet, in which the generated data “0” is stored, is generated.

In contrast, as shown in, for example, a part (B) of FIG. 7, when an input for executing print of the image forming job is received by that the user operates the print hold button 16-2, “1”, which is data indicating to execute print of the image forming job is generated based on the set data for executing print of the image forming job, and a user packet, in which the generated data “1” is stored, is generated.

Note that the user packet is further added with job packets J (job packets J11, J12, and the like) in which the image forming data PD (for example, image forming data PD11, PD12, and the like) are included and with a packet in which the identification data (for example, IP address, MAC address, and the like) for identifying the personal computers 2 are stored.

The user packet generating unit 44 supplies the generated user packet to the transmission unit 45.

In Step S5, the transmission unit 45 obtains the user packet-supplied from the user packet generating unit 44 and transmits the obtained user packet to the image forming apparatus 4 via the network 3 as the image forming job.

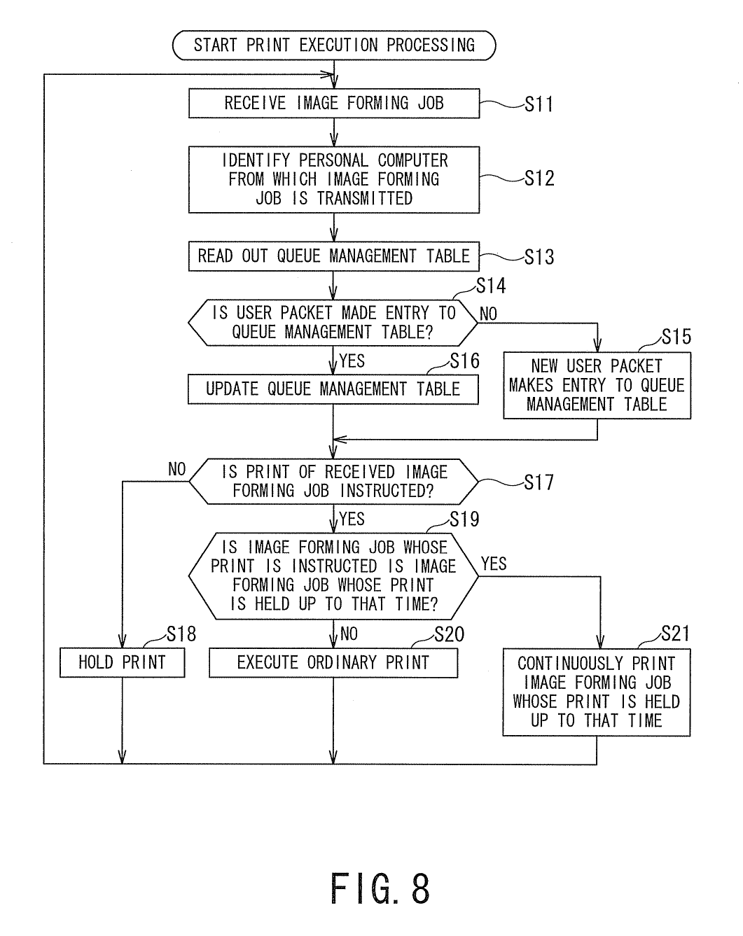

Next, a print execution processing in the image forming apparatus 4 of FIG. 5 will be explained referring to a flowchart of FIG. 8.

In Step S11, the receiving unit 51 appropriately receives the image forming jobs transmitted from the personal computers 2 (personal computers 2-1 to 2-n) via the network 3, respectively and supplies the received image forming jobs to the queue management unit 52.

In Step S12, the identification unit 55 of the queue management unit 52 obtains the image forming jobs supplied from the receiving unit 51 and identifies the personal computers 2 from which the image generating jobs are transmitted based on the identification data (for example, IP address, MAC address, and the like for identifying the respective personal computers 2) included in the user packets of the obtained image forming jobs.

In other words, a user, who operates a personal computer 2 from which an image forming job is transmitted, is identified among the users who operate the plurality of the personal computers 2 (for example, the personal computers 2-1 to 2-n) connected to the network 3.

In Step S13, the update unit 56 of the queue management unit 52 reads the queue management table 57 managed by the queue management unit 52.

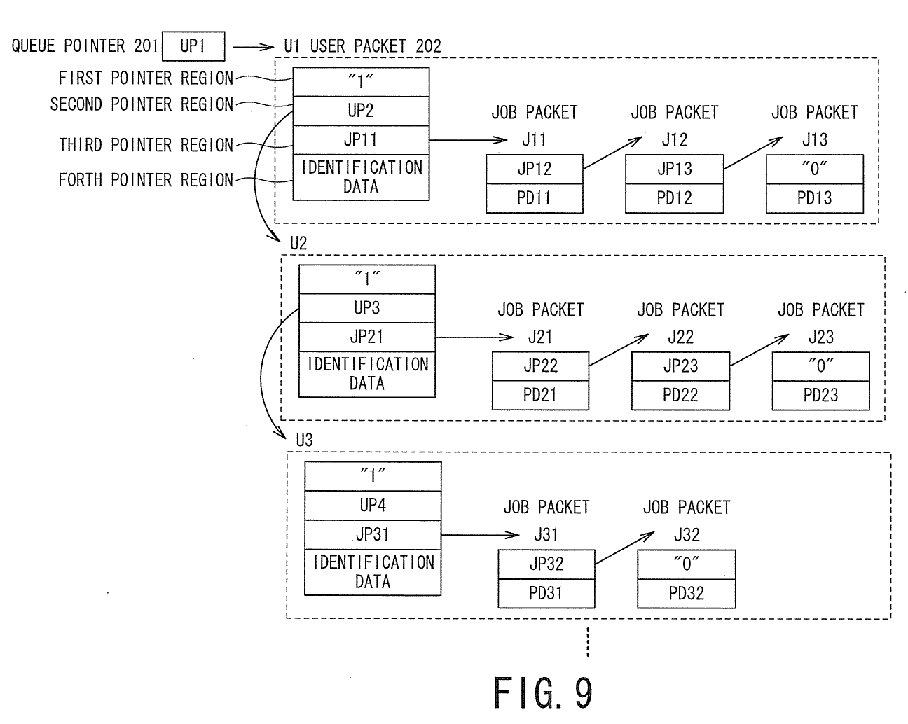

FIG. 9 shows an construction example of the queue management table 57 managed by the queue management unit 52. For example, as shown in FIG. 9, the queue management table 57 is composed of a queue pointer 201 and a user packet 202. The leading address UP1 of a foremost user packet 202 is written to the queue pointer 201.

The user packet 202 is composed of a plurality of regions (for example, first to fourth pointer regions). The user packet 202 is shown by, for example, U1, U2, U3, . . . and generated (made) to each of the personal computers 2. Note that, for example, U1 is a user packet 202 generated (made) by the personal computer 2-1 and, for example, U2 a user packet 202 generated (made) by the personal computer 2-2.

The data (“0” or “1”), which shows whether print of an image forming job is to be held or executed, is stored to the first pointer region of the user packet 202. The leading addresses UP2, UP3, UP4, and the like of the user packet of an image forming job to be processed next is written to the second pointer region of the user packet 202. The leading addresses JP11, JP12 of a job packet J are written to the third pointer region of the user packet 202. The identification data (for example, IP address, and MAC address, and the like) for identifying the personal computers 2 is written to the fourth pointer region of the user packet 202.

In Step S14, the update unit 56 determines whether or not the identification data (for example, IP address, MAC address, and the like) for identifying the personal computer 2 from which the image forming job is transmitted already makes entry to the queue management table 57 according to the result of identification supplied from the identification unit 55.

When it is determined in Step S14 that the identification data does not yet make entry to the queue management table 57, the update unit 56 recognizes in Step S15 that the personal computer 2 is not the same as any of the personal computers 2 (that is, the users) from which the user packets, which already make entry to the queue management table 57, are transmitted and, the user packet of the newly received image forming job is caused to make entry to the queue management table 57.

In an example shown in FIG. 9, when a user packet 202 shown by U1 already makes entry to the queue management table 57 after a user packet 202, which is shown by U1 and transmitted from the personal computer 2-1, is received by the image forming apparatus 4, and then a user packet shown by U2 and transmitted from the personal computer 2-2 is received by the image forming apparatus 4, it is determined that the user packet does not yet make entry to the queue management table 57, a new user packet 202 shown by U2 makes entry to the queue management table 57, and a job packet J shown by, for example, J21 makes entry thereto.

Further, when a user packet, which is shown by U3 and transmitted from the personal computers 2-3, is received by the image forming apparatus 4 in a state that the user packets 202 shown by U1 and U2 already make entry to the queue management table 57 and then, it is determined that the user packet does not yet make entry to the queue management table 57, a new user packet 202 shown by U3 makes entry to the queue management table 57, and a job packet J shown by, for example, J31 makes entry thereto.

It is needless to say that when the user packet, which is shown by U1 and transmitted from the personal computer 2-1, is received by the image forming apparatus 4 in a state that any user packet does not make entry to the queue management table 57, it is determined that the user packet does not make entry to the queue management table 57 as well as a new user packet 202 shown by U1 makes entry to the queue management table 57.

In contrast, when it is determined in Step S14 that the user packet 202 shown by U1 already makes entry to the queue management table 57, the update unit 56 recognizes in Step S16 that the personal computer 2-1 is the same as any one of the personal computers 2 (that is, the users) from which the user packets, which already make entry to the queue management table 57 and updates the queue management table 57 managed by the queue management unit 52 based on the user packet of the image forming job received via the network 3.

As shown in, for example, FIG. 9, in the user packet 202 shown by U1, when a new job packet J is received next to a job packet J shown by J11, a job packet J shown by J12 is added to the queue management table 57. Image forming data PD12 showing the contents to be printed is written to the job packet J shown by J12. At the time, the leading address JP12 of a next job packet J is written to the job packet J which is shown by J11 and already makes entry to the queue management table. Note that since the job packet J shown by J12 is not yet followed by a next job packet J, the leading address of the next job packet J is set to “0”.

Thereafter, when a new job packet J is further received, a job packet J shown by J13 is added to the queue management table 57. Image forming data PD13 showing the contents to be printed is already written to the job packet J shown by J13. At the time, the leading address JP13 of a next job packet J is written to the job packet J which is shown by J12 and already makes entry to the queue management table. Note that since the job packet J shown by J13 is not yet followed by the next job packet J, the leading address of the next job packet J is set to “0”.

Note that when the queue management table 57 is updated in the processing in Steps S14 to S16, the first pointer regions of the respective user packets 202 are appropriately updated based on the data (“0” or “1”) showing whether print of the image forming job included in the user packet of the received the image forming job is to be held or executed.

In Step S17, the print/hold execution determination unit 53 reads a latest queue management table 57 managed by the queue management unit 52 and determines whether or not print of the image forming job received via the network 3 is instructed.

That is, it is determined whether or not print of the image forming job received via the network 3 is instructed based on the data (“0” or “1”) which is written to the first pointer region of the user packet 202 in the queue management table 57 and shows whether print of the image forming job is to be held or executed.

More specifically, when the data, which shows whether print of the image forming job is to be held or executed, is “0”, it is determined that print of the image forming job received via the network 3 is not instructed (that is, it is determined that the image forming job is instructed to be held).

In contrast, when the data, which shows whether print of the image forming job is to be held or executed, is “1”, it is determined that print of the image forming job received via the network 3 is instructed.

The print/hold execution determination unit 53 supplies a result of determination to the print/hold execution unit 54.

When it is determined in Step S17 that print of the image forming job received via the network 3 is not instructed, (that is, when it is determined that print of the image forming job is instructed to be held), the print/hold execution unit 54 holds in Step S18 print of the image forming job received via the network 3 according to the result of determination supplied from the print/hold execution determination unit 53.

That is, when it is determined that print of the image forming job is instructed to be held at the time that the user packet of the image forming job received via the network 3 is the user packet 202 shown by U1 (that is, when the user packet of the image forming job received via the network 3 is the user packet of the image forming job transmitted from the personal computers 2-1), all the jobs included in the user packet 202 shown by U1 are held. More specifically, when the jobs included in the user packet 202 shown by U1 at the time are composed of the job packets J shown by J11 to J13, all of these jobs are held. It is needless to say that whether print of image forming jobs is to be held or executed is managed for each of the user packet, in other words, for each of the personal computers 2 (users), and the print hold processing is executed to each of the user packets.

Thus, unless a user instructs to print the image forming jobs being held up to that time by operating the input unit of a personal computer 2, print of all the image forming jobs transmitted to the image forming apparatus 4 via the network 3 continues to be held temporarily without being executed.

Thereafter, the process returns to step S11, and the processing in Step S11 and subsequent steps are repeated likewise.

In contrast, when it is determined in Step S19 that print of the image forming job received via the network 3 is instructed, the print/hold execution unit 54 determines in Step S19 the image forming job whose print is instructed is the image forming job whose print is held up to that time.

When it is determined in Step S19 that the image forming job whose print is instructed is not the image forming job whose print is held up to that time, the print/hold execution unit 54 regards that the image forming job whose print is instructed is to be ordinarily printed because it is not the image forming job whose print is held and ordinarily prints the image forming job whose print is instructed independently in Step S20.

Thereafter, the process returns to step S81, and the processing in Step S11 and subsequent steps are repeated likewise.

In contrast, when it is determined in Step S19 that the image forming job whose print is instructed is the image forming job whose print is held up to that time, the print/hold execution unit 54 continuously print the image forming jobs held up that time in Step S21.

Specifically, as shown in, for example, FIG. 9, in the user packet 202 shown by U1, the job packets J shown by J11 to J13 already exist as the image forming jobs whose print is already held. Accordingly, when print of the image forming job of the user packet 202 shown by U1 is instructed, all the job packets J which are temporarily held up to that time are continuously printed in the sequence of J11, J12, and J13 (that is, print is continuously executed based on the image forming data PD11 to PD13 written to the job packets J shown by J11 to J13). However, when, for example, job packets J shown by, for example, J11 to J1n exist to the user packet 202 shown by U1 as the image forming jobs whose print is held at the time, the job packets J are continuously printed in the sequence of J11, J12, J13, . . . , J1n (that is, print is continuously executed based on the image forming data PD11 to PD1n written to the job packets J shown by J11 to J1n).

Likewise, in the user packet 202 shown by U2, the job packets J shown by J21 to J23 already exist as the image forming jobs whose print is held at the time. Accordingly, when it is instructed to print the image forming job of the user packet 202 shown by U2, the job packets J are continuously printed in the sequence of J21, J22, and J23.

Further, in the user packet 202 shown by U3, the job packets J shown by J31 to J33 already exist as the image forming jobs whose print is held at the time. Accordingly, when it is instructed to print the image forming job of the user packet 202 shown by U2, the job packets J are continuously printed in the sequence of J31, J32, and J33.

The print/hold execution unit 54 obtains the result of determination supplied from the print/hold execution determination unit 53 and controls the image forming unit 35 based on the obtained result of determination to thereby hold or print the image forming job received via the network 3.

Note that, on the completion of print, when the job packets J having been executed are sequentially deleted from the queue management table 57 and all the job packets J whose print is held (for example, the job packets J shown by J11 to J13) are deleted from the queue management table 57, the user packets of them which make entry to the queue management table 57 are also deleted therefrom.

Thereafter, the process goes to step S11, and the processing in Step S11 and subsequent steps are repeatedly executed.

In the embodiment of the present invention, the image forming job transmitted from a personal computer 2 via the network 3 is appropriately received, and the personal computer 2 from which the image generating job is transmitted is identified based on the identification data included in the user packet of the received image forming job. Then, it is determined whether or not identification data for identifying the personal computer 2, from which the image forming job is transmitted, already makes entry to the queue management table 57 according to a result of identification. Then, it is recognized based on a result of determination whether or not the personal computer 2 is the same as any one of the personal computers 2 from which the user packets, which already make entry to the queue management table 57, are transmitted, thereby it is possible to update the queue management table 57 based on the user packets of the image forming jobs received via the network 3.

Then, it is determined whether or not print of an image forming job received via the network 3 is instructed based on a latest queue management table 57 managed by the queue management unit 52, and when it is determined that print of it is not instructed, print of it can be held.

In contrast, when it is determined that print of the image forming job received via the network 3 is instructed, it is determined whether or not the image forming job whose print is instructed is the same as the image forming job whose print is held up to that time. Then, when it is determined that the image forming job whose print is instructed is not the image forming job whose print is held up to that time, it is regarded that the image forming job whose print is instructed is to be ordinarily printed and ordinarily printed independently. In contrast, when it is determined that the image forming job whose print is instructed is the image forming job whose print is held up to that time, the image forming job whose print is held can be continuously printed.

Thus, when a user causes the image forming apparatus 4 to hold the image forming data PD1 by operating the print hold button 16-1 of a personal computer 2 and subsequently instructs the image forming apparatus 4 to print the mage forming data PD 2 by operating the print execution button 16-2 of the personal computer 2, the image forming data PD1 and PD2 can be continuously printed by the image forming apparatus 4.

Likewise, when the user causes the image forming apparatus 4 to hold image forming data PD1, PD2, PD3, . . . , PD(n) by operating the print hold button 16-1 of the personal computer 2 and subsequently instructs the image forming apparatus 4 to print mage forming data PD(n+1) by operating the print execution button 16-2 of the personal computer 2, the image forming data PD1 to PD(n+1) can be continuously printed by the image forming apparatus 4.

Accordingly, during a predetermined period of time in which the jobs of a user are executed in a lot, since the image forming apparatus is not occupied by only one user, the users can hold the image forming data at any time when they want to hold it, and when they want to print the held image forming data in a lot, they can cause the image forming apparatus to pint it in a lot. As described above, it is possible to continuously execute a plurality of jobs at a timing the users want. As a result, user-friendliness when the image forming apparatus 4 executes print can be improved.

Incidentally, it is contemplated, for example, a case in which after a user causes the image forming apparatus 4 to hold print of an image forming job while instructing print of the image forming job, the user forgets that image forming job is held or the user cannot instruct to print the image forming job due to unexpected job. In this case, since the image forming job whose print is temporarily held is left without being printed for a long time, a problem of security occurs. Further, when such a case occurs frequently, there is a possibility that the capacity of a memory for storing and managing the image forming job is saturated. As a method of coping with this problem, a time period passed from the time at which the user packet of an image forming job makes entry to the queue management table 57 may be managed, and when a preset predetermined time period passes from the time of the entry thereof, all the image forming jobs whose print is held up to that time may be forcibly printed. Further, when the preset predetermined time period passes, it may be assumed that the image forming job whose print is instructed to be held is abandoned, and the image forming job may deleted. A print execution processing using the method will be explained below.

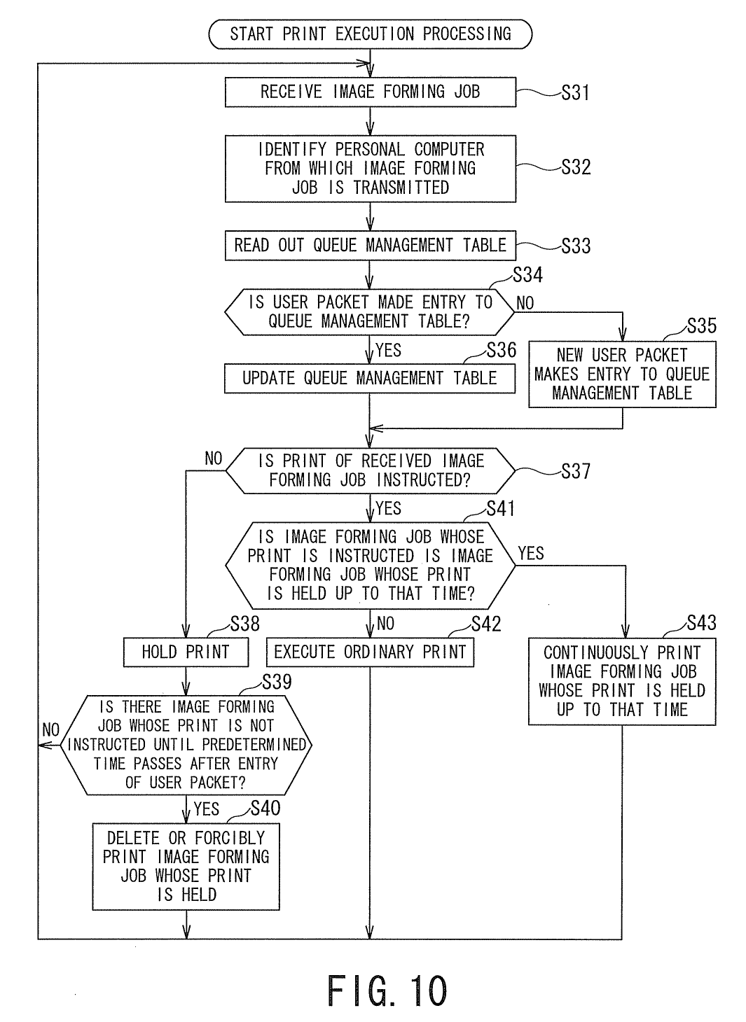

Another print execution processing in the image forming apparatus 4 of FIG. 5 will be explained with reference to a flowchart of FIG. 10. Note that since the processing in Steps S31 to S38 and steps S41 to S43 of FIG. 10 are fundamentally the same as those in Steps S11 to step 21 of FIG. 8, they are not explained repeatedly.

Note that when the queue management table 57 is appropriately updated by the processing in Step S34 to S36 based on the user packets of received image forming jobs, the queue management unit 52 sets a timer when each of the user packets of the image forming jobs makes entry to the queue management table 57 for the first time and manages a time period that passes from the time at which the user packet makes the entry.

In Step S39, the print/hold execution determination unit 53 determines whether or not there is any image forming job whose print is not instructed until a preset predetermined time (for example, 30 minutes and the like) passes after the user packet of the image forming job makes entry to the queue management table 57 with reference to a read out queue management table 57.

When it is determined at step S39 that there is no image forming job whose print is not instructed until the preset predetermined time passes after the entry of the user packet thereof to the queue management table 57, the process returns to step S31, and the processing at step S31 and subsequent steps are repeated.

In contrast, when it is determined at step S39 that there is an image forming job whose print is not instructed until the preset predetermined time passes after the entry of the user packet thereof to the queue management table 57, the print/hold execution determination unit 53 deletes or forcibly print at step 40 the image forming job whose print is not instructed until the preset predetermined time passes among the image forming jobs being held.

Specifically, as shown in, for example, FIG. 9, in the user packet 202 shown by U1, since there are already the job packets J shown by J11 to J13 as the image forming jobs whose print is held at that time, when it is determined that there is an image forming job whose print is not instructed until the preset predetermined time passes after the entry of the user packet thereof to the queue management table 57, all the job packets J whose print is held up to that time are deleted or forcibly printed.

Thereafter, the processing returns to step S11, and the processing at step S11 and subsequent steps are repeated.

Thus, when an image forming job is left for a long time period without being printed due to the circumstances of a user, the image forming job can be deleted or forcibly printed. Accordingly, not only a problem of security caused by an image forming job being held without being printed for a long time period can be overcome but also the capacity of the memory for storing and managing image forming jobs can be prevented from being saturated. As a result, when the image forming apparatus 4 executes print, user-friendliness can be improved.

It is needless to say that whether an image forming job whose print is instructed to be held is to be forcibly printed or to be deleted after the preset predetermined time passes may be previously set.

Note that when an image forming job is left without being printed for a long time period and the preset predetermined time (for example, 30 minutes and the like) passes after the entry of the user packet thereof to the queue management table 57, this status may be notified to a user. A second embodiment of the present invention will be explained below.

### Second Embodiment

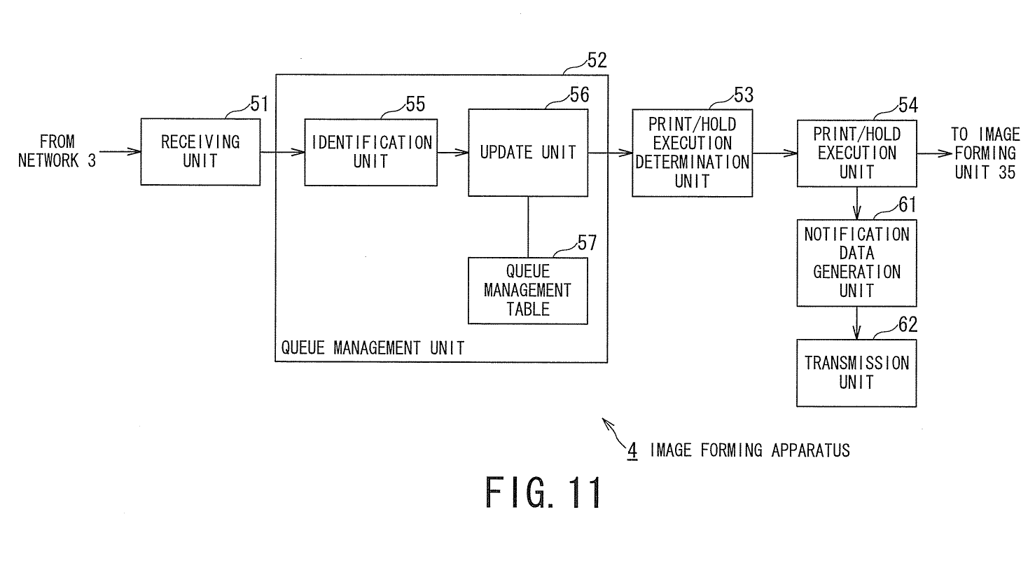

FIG. 11 shows a functional construction that can be executed by the image forming apparatus 4 of FIG. 1. Note that the constructions in FIG. 11 corresponding to those of FIG. 5 are denoted by the same reference numerals are not explained repeatedly. Further, since the constructions explained using FIG. 1 to FIG. 4 are also employed in FIG. 11, they are not explained repeatedly.

A notification data generating unit 61 generates notification data to notify a user that a preset predetermined time (for example, 30 minutes and the like) has passed after the user packet of an image forming job makes entry to the queue management table 57 according to an instruction from a print/hold execution unit 54 and supplies the generated notification data to a transmission unit 62.

The transmission unit 62 obtains the notification data supplied from the notification data generating unit 61 and transmits it to personal computers 2 via a network 3.

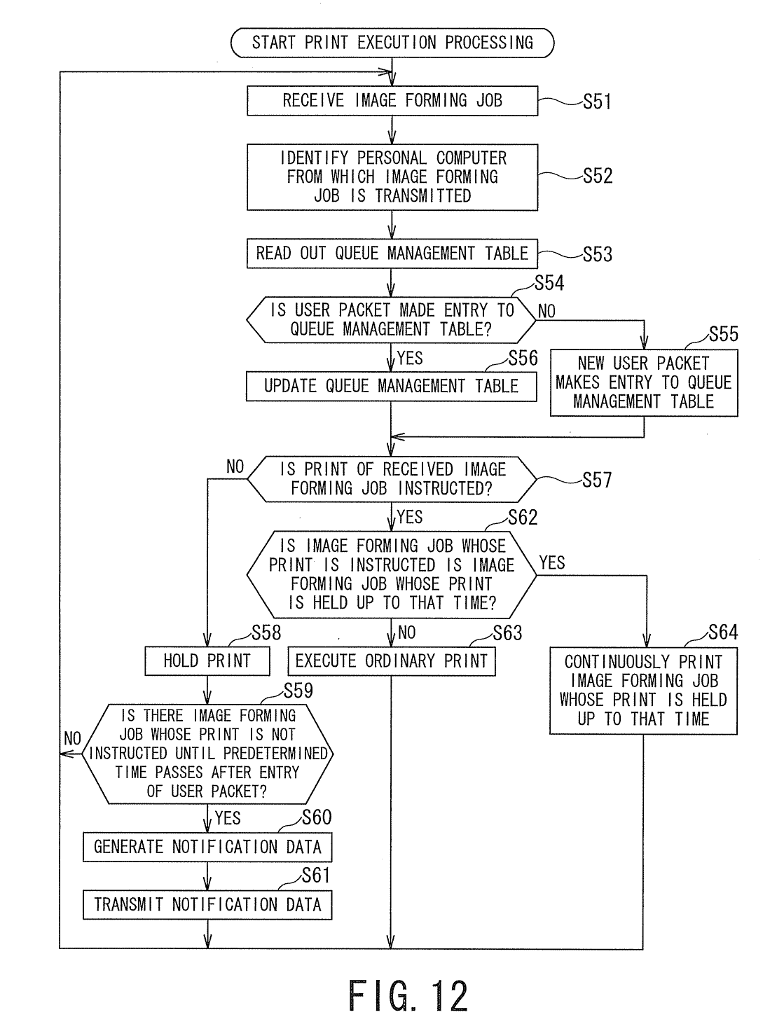

Next, a print execution processing executed by an image forming apparatus 4 of FIG. 11 will be explained with reference to a flowchart of FIG. 12. Note that since the processing at steps S51 to S59 and steps S62 to S64 of FIG. 12 are the same as those at step 531 to S39 and steps 541 to 543 of FIG. 10, they are not explained repeatedly.

When it is determined at step S59 that there is an image forming job whose print is not instructed until the preset predetermined time (for example, 30 minutes and the like) passes after the user packet of the image forming job makes entry to the queue management table 57, the notification data generating unit 61 generates notification data for notifying the user that the preset predetermined time has passed after the entry of the user packet to the queue management table 57 at step S60 according to the instruction from the print/hold execution unit 54.

The notification data includes, for example, display data for causing output units 17 of the personal computers 2 operated by users to display that the preset predetermined time has passed after the entry of the user packet to the queue management table 57 in a dialogue message and the like. It is needless to say that the notification data may include voice data for causing the output units 17 of the personal computers 2 operated by the users to output that the preset predetermined time has passed after the entry of the user packet to the queue management table 57 in a voice and the like.

The notification data generating unit 61 supplies the generated notification data to the transmission unit 62.

In Step S61, the transmission unit 62 obtains the notification data supplied from the notification data generating unit 61 and transmits it to the personal computers 2 via the network 3. Thus, it is possible to output that the preset predetermined time has passed after the entry of the user packet to the queue management table 57 to the personal computers 2 operated by the users in the dialogue message or the voice. As a result, user can be notified of it.

Note that this display may be made on a not shown display unit of the image forming apparatus 4 in addition to the personal computers 2 operated by the users.

Further, just after the notification is issued, an image forming job whose print is held may be forcibly printed or deleted.

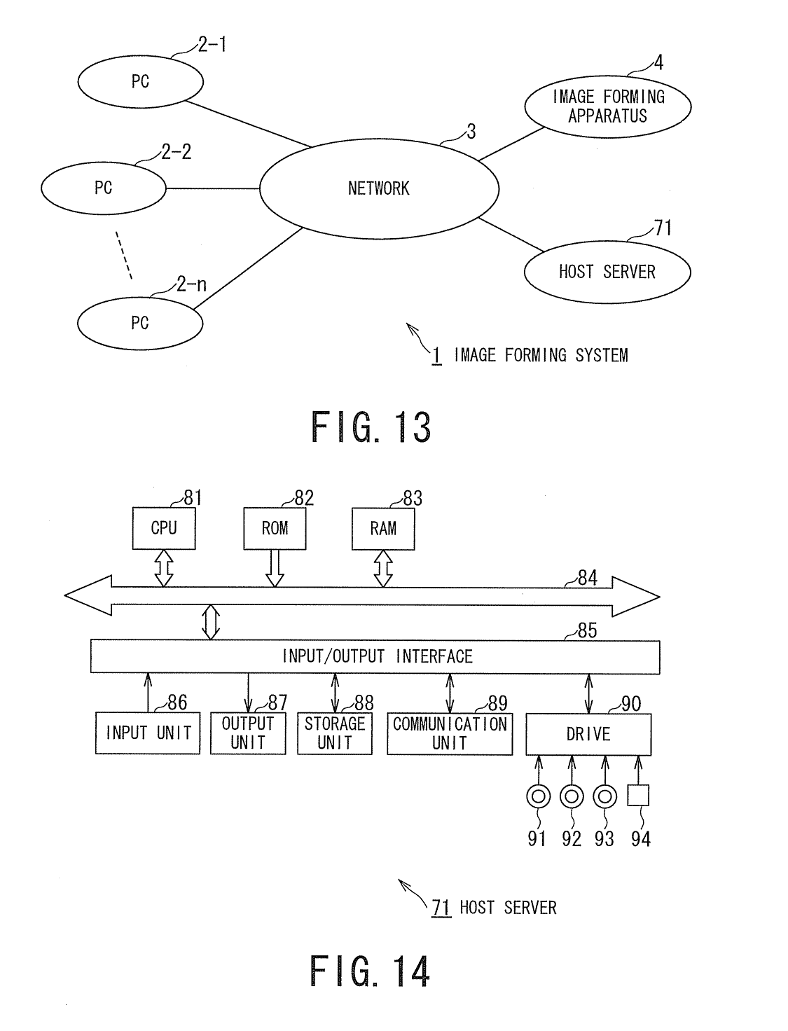

Incidentally, in the cases of FIGS. 1 to 12, although the queue management unit (queue management unit 52 in the examples of FIGS. 5 and 11) is disposed to the image forming apparatus 4 to manage the queue management table (queue management table 57 in the examples of FIGS. 5 and 11), a queue management unit for managing the queue management table may be disposed to a host server 71 connected to the network 3 as shown in, for example, FIG. 13, in addition to the above cases

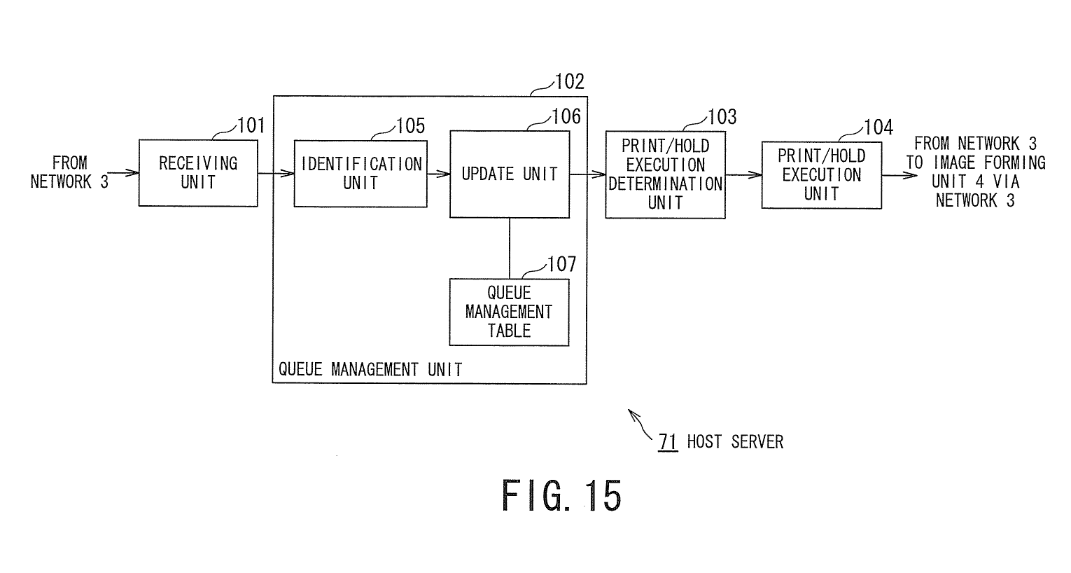

FIG. 14 shows an internal construction of the host server 71. Note that since the internal construction is fundamentally the same as that of the personal computer of FIG. 2, it is not explained repeatedly. Further, FIG. 15 shows a functional construction which can be executed by the host server 71 of FIG. 14. Since the functional construction shown in FIG. 15 is fundamentally the same as that shown in FIG. 5, it is not repeatedly explained.

Although a series of the processing explained in the embodiment of the present invention may be executed by software, it may be also executed by hardware.

Further, in the embodiment of the present invention, although the steps of the flowcharts show examples of the processing which are executed time sequentially according to sequences shown in the drawings, the processing need not necessarily be executed time sequentially and include some processing which are executed in parallel or individually.

What is claimed is:

1. An image forming system comprising a plurality of information processing apparatuses each transmitting an image forming job and an image forming apparatus connected to the information processing apparatuses via a network for executing the image forming job transmitted from each of the information processing apparatuses, wherein:
each of the information processing apparatuses comprises:
an input receiving unit configured to receive an input whether print of the image forming job is to be held or executed;
a setting unit configured to set whether print of the image forming job is to be held or executed based on the input, which is received by the input receiving unit, whether print of the image forming job is to be held or executed;
a generation unit configured to generate a user packet by using the set data, which is set by the setting unit, whether print of the image forming job is to be held or executed and by using the image forming data included in an obtained print request; and
a transmission unit configured to transmit the user packet generated by the generation unit to the image forming apparatus as the image forming job, and,
the image forming apparatus comprises:
a receiving unit configured to receive the image forming job transmitted by the transmission unit from each of the information processing apparatuses;
an identification unit configured to identify the information processing apparatus from which the image forming job is transmitted from the plurality of the image processing apparatuses connected to the network based on identification data for identifying the information processing apparatus included in the image forming job received by the receiving unit;
an update unit configured to update a queue management table for managing the image forming job in accordance with a result of identification identified by the identification unit based on the image forming job received by the receiving unit;
a determination unit configured to determine whether or not print of the image forming job received by the receiving unit is instructed referring to the queue management table updated by the update unit; and
a print/hold execution unit configured to hold print of the image forming job when it is determined by the determination unit that hold of print of the image forming job is instructed and continuously and sequentially print the image forming jobs whose print is held up to that time when it is determined by the determination unit that print of the image forming job is instructed.

2. An image forming system comprising a plurality of information processing apparatuses each transmitting an image forming job, an information managing apparatus connected to the information processing apparatuses via a network for managing the image forming job transmitted from each of the information processing apparatuses, and an image forming apparatus connected to the information processing apparatuses and the information managing apparatus via the network for executing the image forming job transmitted from the information managing apparatus, wherein:
each of the information processing apparatuses comprises:
an input receiving unit configured to receive an input whether print of the image forming job is to be held or executed;
a setting unit configured to set whether print of the image forming job is to be held or executed based on the input, which is received by the input receiving unit, whether print of the image forming job is to be held or executed;
a generation unit configured to generate a user packet by using the set data, which is set by the setting unit, whether print of the image forming job is to be held or executed and by using the image forming data included in an obtained print request; and
a transmission unit configured to transmit the user packet generated by the generation unit to the image forming apparatus as the image forming job, and,
the information managing apparatus comprises:
a receiving unit configured to receive the image forming job transmitted by the transmission unit from each of the information processing apparatuses;
an identification unit configured to identify the information processing apparatus from which the image forming job is transmitted from the plurality of the image processing apparatuses connected to the network based on identification data for identifying the information processing apparatus included in the image forming job received by the receiving unit;
an update unit configured to update a queue management table for managing the image forming job in accordance with a result of identification identified by the identification unit based on the image forming job received by the receiving unit;
a determination unit configured to determine whether or not print of the image forming job received by the receiving unit is instructed referring to the queue management table updated by the update unit; and
a print/hold execution unit configured to cause the image forming apparatus to hold print of the image forming job when it is determined by the determination unit that hold of print of the image forming job is instructed and to cause the image forming apparatus to continuously and sequentially print the image forming jobs whose print is held up to that time when it is determined by the determination unit that print of the image forming jobs is instructed.

3. An image forming apparatus comprising:
a receiving unit configured to receive an image forming job transmitted from each of a plurality of information processing apparatuses connected to an image forming apparatus via a network;
an identification unit configured to identify the information processing apparatus from which the image forming job is transmitted from the plurality of image processing apparatuses connected to the network based on identification data for identifying the information processing apparatus included in the image forming job received by the receiving unit;
an update unit configured to update a queue management table for managing the image forming job in accordance with a result of identification identified by the identification unit based on the image forming job received by the receiving unit;
a first determination unit configured to determine whether or not print of the image forming job received by the receiving unit is instructed referring to the queue management table updated by the update unit; and
a print/hold execution unit configured to hold print of the image forming job when it is determined by the first determination unit that hold of print of the image forming job is instructed and continuously and sequentially print the image forming job whose print is held up to that time when it is determined by the first determination unit that print of the image forming job is instructed.

4. An image forming apparatus according to claim 3, wherein the queue management table comprises at least a first pointer region in which data showing whether print of the image forming job is to be held or executed is stored, a second pointer region to which the leading address of the user packet of the image forming job to be processed next is written, a third pointer region to which a job packet showing job contents is written, and a fourth pointer region to which identification data for identifying the information processing apparatuses is written.

5. An image forming apparatus according to claim 3, wherein the identification data includes at least any one of an IP address and a MAC address of each of the information processing apparatuses.

6. An image forming apparatus according to claim 3, further comprising a second determination unit configured to determine, when it is determined by the first determination unit that print of the image forming job is instructed, whether or not the image forming job whose print is instructed is the image forming job whose print is held up to that time,
wherein when the second determination unit determines that the image forming job whose print is instructed is not the image forming job whose print is held up to that time, the print/hold execution unit prints the received image forming job, whereas when the second determination unit determines that the image forming job whose print is instructed is the image forming job whose print is held up to that time, the print/hold execution unit continuously and sequentially prints the image forming job whose print is held up to that time.

7. An image forming apparatus according to claim 3 further comprising a second determination unit configured to determine, when print of the image forming job is held by the print/hold execution unit, whether or not print of the image forming job is instructed until a preset predetermined time passes after the image forming job makes entry to the queue management table referring to the queue management table,
wherein when it is determined by the second determination unit that print of the image forming job is not instructed until the preset predetermined time passes after the image forming job makes entry to the queue management table, the print/hold execution unit deletes or forcibly prints the image forming job whose print is held up to that time.

8. An image forming apparatus according to claim 7, further comprising:
a generation unit configured to generate, when it is determined by the second determination unit that print of the image forming job is not instructed until the preset predetermined time passes after the image forming job makes entry to the queue management table, notification data for notifying the above fact to a user who operates the information processing apparatus; and
a transmission unit configured to transmit the notification data generated by the generation unit to the information processing apparatus.

9. A method of controlling an image forming apparatus comprising:
receiving an image forming job transmitted from each of information processing apparatuses connected to an image forming apparatus via a network;
identifying the information processing apparatus from which the image forming job is transmitted from the plurality of information processing apparatuses connected to the network based on identification data for identifying the information processing apparatus included in the image forming job processing apparatus received;
updating a queue management table for managing the image forming job in accordance with a result of identification executed based on the image forming job received;
determining whether or not print of the image forming job received is instructed referring to the queue management table updated; and
holding print of the image forming job when it is determined that hold of print of the image forming job is instructed and for continuously and sequentially printing the image forming job whose print is held up to that time when it is determined that print of the image forming job is instructed.

10. A control program of an image forming apparatus, wherein the control program causes a computer to execute:
receiving an image forming job transmitted from each of information processing apparatuses connected to an image forming apparatus via a network;
identifying the information processing apparatus from which the image forming job is transmitted from the plurality of information processing apparatuses connected to the network based on identification data for identifying the information processing apparatus included in the image forming job processing apparatus received;
updating a queue management table for managing the image forming job in accordance with a result of identification executed based on the image forming job received;
determining whether or not print of the image forming job received is instructed referring to the queue management table updated; and
holding print of the image forming job when it is determined that hold of print of the image forming job is instructed and for continuously and sequentially printing the image forming job whose print is held up to that time when it is determined that print of the image forming job is instructed.

11. An information managing apparatus comprising:
a receiving unit configured to receive an image forming job transmitted from each of a plurality of information processing apparatuses connected to an information managing apparatus via a network;
an identification unit configured to identify the information processing apparatus from which the image forming job is transmitted from the plurality of image processing apparatuses connected to the network based on identification data for identifying the information processing apparatus included in the image forming job received by the receiving unit;
an update unit configured to update a queue management table for managing the image forming job in accordance with a result of identification identified by the identification unit based on the image forming job received by the receiving unit;
a determination unit configured to determine whether or not print of the image forming job received by the receiving unit is instructed referring to the queue management table updated by the update unit; and
a print/hold execution unit configured to cause the image forming apparatus connected via the network to hold print of the image forming job when it is determined by the determination unit that hold of print of the image forming job is instructed and to cause the image forming apparatus to continuously and sequentially printing the image forming job whose print is held up to that time when it is determined by the determination unit that print of the image forming job is instructed.

12. An information managing apparatus according to claim 11 wherein the queue management table comprises at least a first pointer region in which data showing whether print of the image forming job is to be held or executed is stored, a second pointer region to which the leading address of the user packet of the image forming job to be processed next is written, a third pointer region to which a job packet showing job contents is written, and a fourth pointer region to which identification data for identifying the information processing apparatuses is written.

13. An information managing apparatus according to claim 11, wherein the identification data includes at least any one of an IP address and a MAC address of each of the information processing apparatuses.

14. An information managing apparatus according to claim 11 further comprising a second determination unit configured to determine, when it is determined by the first determination unit that print of the image forming job is instructed, whether or not the image forming job whose print is instructed is the image forming job whose print is held up to that time,
wherein when the second determination unit determines that the image forming job whose print is instructed is not the image forming job whose print is held up to that time, the print/hold execution unit causes the image forming apparatus to print the received image forming job, whereas when the second determination unit determines that the image forming job whose print is instructed is the image forming job whose print is held up to that time, the print/hold execution unit causes the image forming apparatus to continuously and sequentially print the image forming job whose print is held up to that time.

15. An information managing apparatus according to claim 11 further comprising a second determination unit configured to determine, when print of the image forming job is held by the print/hold execution unit, whether or not print of the image forming job is instructed until a preset predetermined time passes after the image forming job makes entry to the queue management table referring to the queue management table,
wherein when it is determined by the second determination unit that print of the image forming job is not instructed until the preset predetermined time passes after the image forming job makes entry to the queue management table, the print/hold execution unit causes the image forming apparatus to delete or forcibly print the image forming job whose print is held up to that time.

16. An information managing apparatus according to claim 11 further comprising:
a generation unit configured to generate, when it is determined by the second determination unit that print of the image forming job is not instructed until the preset predetermined time passes after the image forming job makes entry to the queue management table, notification data for notifying the above fact to a user who operates the information processing apparatus; and
a transmission unit configured to transmit the notification data generated by the generation unit to the information processing apparatus.

17. An information managing method comprising:
receiving an image forming job transmitted from each of information processing apparatuses connected to an information managing apparatus via a network;
identifying the information processing apparatus from which the image forming job is transmitted from the plurality of information processing apparatuses connected to the network based on identification data for identifying the information processing apparatus included in the image forming job processing apparatus received;
updating a queue management table for managing the image forming job in accordance with a result of identification executed based on the image forming job received;
determining whether or not print of the image forming job received is instructed referring to the queue management table updated; and
causing an image forming apparatus connected via the network to hold print of the image forming job when it is determined that hold of print of the image forming job is instructed and for causing the image forming apparatus to continuously and sequentially print the image forming job whose print is held up to that time when it is determined that print of the image forming job is instructed.

18. An information managing program, wherein the information managing program causes a computer to execute:
receiving an image forming job transmitted from each of a plurality of information processing apparatuses connected to an information managing apparatus via a network;
identifying the information processing apparatus from which the image forming job is transmitted from the plurality of information processing apparatuses connected to the network based on identification data for identifying the information processing apparatus included in the image forming job processing apparatus received;
updating a queue management table for managing the image forming job in accordance with a result of identification executed based on the image forming job received;
determining whether or not print of the image forming job received is instructed referring to the queue management table updated; and
causing an image forming apparatus connected via the network to hold print of the image forming job when it is determined that hold of print of the image forming job is instructed and for causing the image forming apparatus to continuously and sequentially print the image forming job whose print is held up to that time when it is determined that print of the image forming job is instructed.
